(19) United States
(12) Patent Application Publication
(10) Pub. No.: US 2026/0158702 A1
(43) Pub. Date: Jun. 11, 2026

(54) METHOD, SYSTEM, AND APPARATUS FOR MODULAR WALL CONSTRUCTION WITH EPS LIGHT CONCRETE MOULD-PRESSED HALF PANEL BLOCKS

(71) Applicant: Soleman Abdi IDD, McLean, VA (US)

(72) Inventor: Soleman Abdi IDD, McLean, VA (US)

(21) Appl. No.: 19/415,987

(22) Filed: Dec. 11, 2025

Related U.S. Application Data
(60) Provisional application No. 63/730,561, filed on Dec. 11, 2024.

(51) Int. Cl. B28B 23/22; B28B 23/00; E04F 13/08

(52) U.S. Cl. CPC B28B 23/22; B28B 23/0087; E04F 13/0866; E04F 2290/041

(57) ABSTRACT

Methods, systems, and apparatuses for modular wall construction using lightweight, mould-pressed half-panel blocks made from expanded polystyrene (EPS) or EPS-based mortar, with or without rib-lath steel mesh reinforcement. The panels may provide energy-efficient, lightweight, and structurally robust solutions for load-bearing and non-load-bearing walls. EPS beads embedded in a cement-sand mortar mix may offer thermal and acoustic insulation while reducing panel weight. The panels may be manually assembled by two workers, minimizing the need for heavy machinery. Each half-panel block may measure approximately 1200×600 mm and cover roughly 0.72 square meters of wall surface. The panels may be used as walls, footings, formwork, lintels, or cladding, and structural concrete and reinforcing steel may be added when used as formwork. Panels may be dismantled and reused, supporting sustainable construction practices and modular offsite assembly with pre-sized kits.

### CROSS-REFERENCE TO RELATED APPLICATIONS

This application claims the benefit of U.S. Provisional Application No. 63/730,561, filed Dec. 11, 2024, the entire contents of which are hereby incorporated by reference.

### TECHNICAL FIELD

The embodiments relate to building construction, and to modular wall systems formed from lightweight materials such as expanded polystyrene (EPS) or EPS-based mortar, with or without galvanized steel mesh reinforcement (rib-lath). The embodiments described herein may provide energy-efficient, lightweight, and structurally robust solutions suitable for modern building applications.

### BACKGROUND

Traditional construction methodologies rely heavily on labor-intensive processes, heavy materials, and the extensive use of machinery to prepare foundations, erect walls, and place structural components. Such practices increase construction time, operational costs, and logistical complexity, particularly in regions where access to heavy machinery and skilled operators is limited or impractical, including many developing and remote areas.

Conventional wall systems, including concrete blocks and brick masonry, often require significant structural support and prolonged installation times. These systems typically lack integrated thermal and acoustic insulation, resulting in the need for additional insulation layers or cladding materials. Insulation approaches frequently involve foam boards such as polystyrene sheets, which may degrade when exposed to sunlight and environmental elements, and can also present fire susceptibility and limited mechanical strength.

Timber and light steel framing systems further require external cladding materials to ensure environmental protection and structural stability. Common cladding options include timber, metal panels, fiber cement boards, and rendered finishes, which may increase overall wall thickness, weight, and cost while complicating installation and maintenance. These systems also introduce multiple construction stages, increasing the likelihood of errors, delays, and waste.

Existing EPS-based wall solutions offer improvements in weight reduction and insulation performance. However, many such systems may lack sufficient structural integrity or modular adaptability for broader use in load-bearing applications, multi-story construction, or reusable formwork. Additionally, these conventional systems may be limited in their ability to integrate reinforcement components or accommodate infill materials for enhanced load-bearing performance.

Accordingly, there remains a need for a modular wall construction system that combines lightweight characteristics with structural stability, ease of installation, thermal and acoustic insulation performance, and adaptability for both load-bearing and non-load-bearing applications. There is also a need for construction solutions that facilitate rapid assembly, reduce dependency on heavy machinery, minimize material waste, and support sustainable building practices, including reuse and recyclability.

### SUMMARY

This disclosure provides methods, systems, and apparatuses for modular wall construction using lightweight, mould-pressed half-panel blocks made from expanded polystyrene (EPS) or EPS-based mortar, with or without rib-lath steel mesh reinforcement. The panel blocks may be energy-efficient, lightweight, and structurally robust, suitable for both load-bearing and non-load-bearing applications.

The system includes EPS beads embedded in a cement-sand mortar mix, which may provide thermal and acoustic insulation while reducing the overall weight of the panels. The panels may be assembled manually by two workers, minimizing the need for heavy machinery and reducing construction time. Each half-panel block may measure approximately 1200×600 mm and, when installed, may cover roughly 0.72 square meters of wall surface, requiring only surface painting.

The panels may be used as walls, footings, formwork, lintels, or cladding. When used as formwork, structural concrete and reinforcing steel may be inserted to enhance load-bearing capacity, and the panels may be dismantled and reused in other locations, promoting sustainability. The system may support modular offsite construction through pre-sized kits, reducing waste, errors, and labor costs.

The panel block system may offer multiple advantages. The modular design allows blocks to be cut to fit fractional dimensions. The panels may be manually erected without heavy machinery, simplifying installation. The panels may be dismantled and reassembled, supporting sustainable construction practices. Structural reinforcement may be provided through rib-lath steel mesh and concrete infill to enhance load-bearing capacity. The panels may serve a variety of applications, including walls, formwork, footings, lintels, and cladding. Additionally, production machines may be portable and low-cost, allowing for easy transportation and rapid deployment.

The system may provide a construction solution that is faster, lighter, cost-efficient, and environmentally friendly, while offering thermal and acoustic comfort, structural robustness, and adaptability for a wide range of building applications.

### BRIEF DESCRIPTION OF THE FIGURES

Advantages of the embodiments will be apparent from the following detailed description of the exemplary embodiments. The following detailed description should be considered in conjunction with the accompanying figures in which:

FIG. 1 is an exemplary isometric view of a half-panel block showing a cross-section.

FIG. 2 is an exemplary vertical elevation illustrating two half-panel blocks joined together with glue mortar.

FIG. 3 is an exemplary illustration of two half-panel blocks affixed to a light steel frame to enhance load-bearing capabilities.

### DETAILED DESCRIPTION

Aspects of the invention are disclosed in the following description and related drawings directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

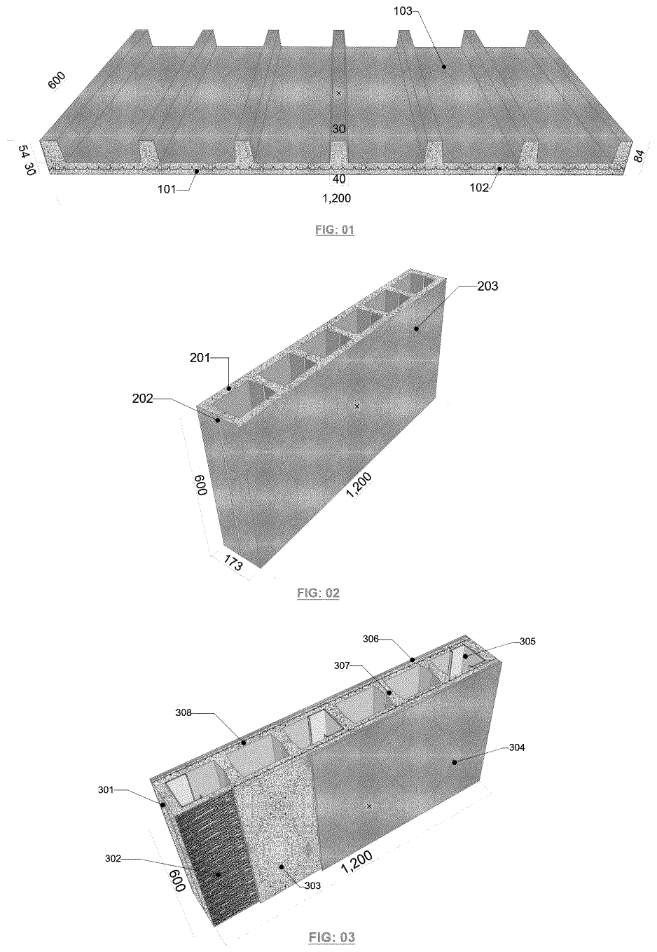

According to an exemplary embodiment, and referring generally to FIGS. 1-3, a modular EPS light concrete mould-pressed half-panel block, with or without rib-lath steel mesh reinforcement, may be as shown and described.

In some embodiments, the panel blocks may measure approximately 1200×600 mm, though other dimensions may be used as desired. Each panel may include galvanized steel mesh (rib-lath) 102 for reinforcement, though in some cases, the mesh may be omitted depending on structural requirements.

In some embodiments, the EPS concrete/mortar 101 shown in FIG. 1 may comprise expanded polystyrene beads embedded in a cement-sand mortar mix. The EPS may enhance thermal and acoustic performance while reducing overall panel weight. The EPS concrete 101 may include, but is not limited to, EPS beads of 2-6 mm thickness, an air integrator, cement, and water. The air integrator may comprise natural lime, river sands, white clay, fly ash, or similar materials. The panels may be designed for manual handling by two workers, facilitating quick installation and reducing the need for heavy machinery.

FIG. 2 shows an exemplary vertical elevation of two half-panel blocks 201 and 203 joined with glue mortar 202. In some embodiments, when joined, the panels may replace conventional concrete blocks or bricks for use as load-bearing, non-load-bearing, or cladding walls. The gap between panels may be filled with lightweight mortar, cellular concrete, or other filler to improve rigidity and insulation. Each half-panel block may also serve as formwork for foundations or walls. When used as formwork, the panels may be dismantled and reused in other locations.

In some embodiments, the panels may be used as permanent or semi-permanent cladding capable of withstanding a variety of weather and climate conditions. The panels may be cut to fit fractional measurements, allowing versatility for both temporary and permanent structures. The half-panel blocks may also be used as lintels across building openings. Cladding can be erected without heavy machinery, reducing construction time and carbon emissions.

FIG. 3 shows an exemplary illustration of two half-panel blocks 303 and 308 joined with glue mortar 301 and 307 and affixed to a light steel frame 305 to enhance overall wall load-bearing capacity. In some embodiments, the frame may be made of galvanized steel and may include pre-punched holes for electrical or plumbing installations. The rib-lath steel mesh 302 may be included or omitted depending on structural requirements. The gap between panels may be filled with lightweight mortar, concrete, or other filler for additional rigidity and insulation. The outer surface of the panels may be finished with cement-sand plaster 304 and 306, providing a smooth surface that may only require painting.

In some embodiments, structural concrete and reinforcing steel may be inserted between panels to enhance load-bearing capacity. The reinforced panels may be suitable for walls, footings, foundations, and other structural applications.

The panels may provide thermal and acoustic insulation, reduce overall building weight, and allow faster and more cost-efficient construction. They may be manually erected by two workers, support modular offsite construction via pre-sized kits, and be reused in different locations, promoting sustainability. The panels may serve multiple purposes including walls, footings, formwork, lintels, and cladding, and may include optional structural reinforcement with rib-lath steel mesh and concrete infill.

Alternate configurations, dimensions, and materials may be employed without departing from the scope of the claims. Features described herein may be combined in various ways to provide modular wall systems suitable for diverse building applications while maintaining energy efficiency, structural robustness, and adaptability.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of building construction for forming a modular wall system, comprising:
providing a plurality of mould-pressed lightweight half-panel blocks formed from expanded polystyrene (EPS) mortar;
placing a first half-panel block on a building surface;
joining a second half-panel block to the first half-panel block with glue mortar; and
repeating steps b) and c) to form a wall.

2. The method of claim 1, further comprising reinforcing the half-panel blocks with rib-lath steel mesh.

3. The method of claim 1, further comprising inserting structural concrete and reinforcing steel into spaces defined between the joined half-panel blocks to form a reinforced wall.

4. The method of claim 1, wherein the EPS mortar comprises a mixture of an insulator, an air integrator, cement, and water.

5. The method of claim 4, wherein the air integrator comprises at least one of natural lime, river sands, white clay, or fly ash.

6. A modular wall construction system comprising:
a plurality of mould-pressed lightweight half-panel blocks formed from expanded polystyrene (EPS)-based mortar;
rib-lath steel mesh embedded within each of the half-panel blocks; and
glue mortar configured to join adjacent half-panel blocks;
wherein the joined half-panel blocks define spaces configured to receive structural concrete and reinforcing steel to form a reinforced wall.

7. The modular wall construction system of claim 6, wherein each half-panel block measures approximately 1200×600 mm.

8. The modular wall construction system of claim 6, wherein the EPS-based mortar comprises expanded polystyrene beads embedded in a cement-sand mortar mix.

9. The modular wall construction system of claim 8, wherein the EPS beads have a thickness of 2-6 mm.

10. The modular wall construction system of claim 6, wherein the rib-lath steel mesh comprises galvanized steel.

11. The modular wall construction system of claim 6, wherein the glue mortar comprises a cement-sand mixture.

12. The modular wall construction system of claim 6, wherein two joined half-panel blocks cover a wall surface of about 0.72 square meters, based on each half-panel block measuring approximately 1200×600 mm.

13. The modular wall construction system of claim 6, wherein the half-panel blocks are configured to be dismantled and/or modular.

14. The modular wall construction system of claim 6, further comprising a cement-sand plaster finishing layer on an outer surface of the half-panel blocks.

15. The modular wall construction system of claim 6, wherein the EPS-based mortar further comprises an air integrator selected from the group consisting of natural lime, river sands, white clay, and fly ash.
